(19) United States
(12) Patent Application Publication
(10) Pub. No.: US 2021/0315165 A1
(43) Pub. Date: Oct. 14, 2021

(54) ROTATABLE PLANTER

(71) Applicant: Nathan Adam Tisdale, Chico, CA (US)

(72) Inventor: Nathan Adam Tisdale, Chico, CA (US)

(21) Appl. No.: 16/843,267

(22) Filed: Apr. 8, 2020

(51) Int. Cl. A01G 9/02

(52) U.S. Cl. CPC A01G 9/02

(57) ABSTRACT

A planter including a planter box and a rotatable mounting adapter that couples the planter box to a surface of an object. The adapter includes a first plate configured to directly couple to the planter box, a second plate configured to directly couple to the surface of the object, and one or more ball bearings between the first and second plates that allows the first plate and the planter box to rotate with respect to the second plate.

### FIELD

An embodiment of the disclosure relates to a planter with a rotatable mounting adapter that allows the planter to rotate. Other embodiments are also described.

### BACKGROUND

A planter or planter box is a container for plants to grow in. Specifically, the planter is an empty container in which soil is filled and a plant (or seeds) are planted. Planters come in various shapes and sizes. For instance, some planters are decorative and may be placed inside a house. Such planters may include only one plant, such as a fern. Other planters are larger and may be placed outside a house to hold several different kinds of plants, which may include herbs, vegetables, fruits, and flowers.

### SUMMARY

Although some houses may be equipped to accommodate one or more planters, others may not. For instance, a stand-alone house may reside on a parcel of land that extends beyond the boundaries of the house that allow home owners to install planters. People, however who reside in locations that do not have this excess land may be unable to have planters. For instance, people who live in apartment buildings may only have an outdoor patio area that is surrounded by a ledge or railing. This area may not be optimal for a planter. For example, a planter placed on a floor of a patio may take up valuable space. Also, the planter may not get sufficient sunlight if placed upon the patio floor. To resolve this issue, planters may be placed on the ledge or railing of the patio. This solution, however, may still be less optimal. For example, some plants may grow several feet in various directions, such as tomato plants. Ripen tomatoes may hang over the edge of the ledge. Harvesting these tomatoes may be cumbersome and potentially hazardous since a person might have to reach over the ledge to pick them. Therefore, there is a need for a rotatable planter that a user may rotate with respect to a ledge on which it is attached.

The instant disclosure is directed to a rotatable planter that includes a planter box and a rotatable mounting adapter that couples the planter box to a ledge. For example, the adapter may include two plates: a first plate that is couple to the planter box and a second plate that is coupled to the ledge. Between the plates may be ball bearings. When a user pushes on a side of the planter box, the adapter allows the planter box to rotate. Allowing a user to rotate a planter box has several advantages. For example, when harvesting or pruning a plant that is at an edge of the planter, a user may simply rotate the planter to a location that is optimal for the user. Also, the user may be able to manage the amount of sunlight each plant is receiving. For instance, if some plants on one side of the planter need more light than others, the user may rotate the planter such that the plants that need the light may hang off and away from the ledge, while plants that do not need as much light may hang over the patio floor.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the disclosure are illustrated by way of example and not by way of limitation in the figures of the accompanying drawings in which like references indicate similar elements. It should be noted that references to “an” or “one” embodiment in this disclosure are not necessarily to the same embodiment, and they mean at least one. Also, in the interest of conciseness and reducing the total number of figures, a given figure may be used to illustrate the features of more than one embodiment of the disclosure, and not all elements in the figure may be required for a given embodiment.

FIG. 1 illustrates a perspective view of a planter on top of a ledge according to one embodiment of the present disclosure.

FIG. 2 shows a cross-sectional side view of a rotatable mounting adapter of a planter according to one embodiment of the present disclosure.

FIG. 3 illustrates perspective view of a planter that has rotated atop a ledge on which it is coupled according to one embodiment of the present disclosure.

FIG. 4 shows a cross-sectional side view of a locking mechanism of a planter in a locked position and in an unlocked position according to one embodiment of the present disclosure.

FIG. 5 shows a perspective view of a planter that has a rotatable mounting adapter with a catch container according to one embodiment of the present disclosure.

FIG. 6 shows a perspective view of a cover that is covering a planter according to one embodiment of the present disclosure.

FIG. 7 shows a perspective view of a planter that has at least one trellis according to one embodiment of the present disclosure.

### DETAILED DESCRIPTION

Several embodiments of the disclosure with reference to the appended drawings are now explained. Whenever the shapes, relative positions and other aspects of the parts described in the embodiments are not explicitly defined, the scope of the disclosure is not limited only to the parts shown, which are meant merely for the purpose of illustration. Also, while numerous details are set forth, it is understood that some embodiments of the disclosure may be practiced without these details. In other instances, structures and techniques have not been shown in detail so as not to obscure the understanding of this description. Furthermore, unless the meaning is clearly to the contrary, all ranges set forth herein are deemed to be inclusive of the endpoints. In addition, the terms “over”, “to”, and “on” as used herein may refer to a relative position of one feature with respect to other features. One feature “over” or “on” another feature or bonded “to” another feature may be directly in contact with the other feature or may have one or more intervening layers. In addition, the use of relative terms throughout the description, such as “top”, “above or “upper” and “bottom”, “under” or “lower” may denote a relative position or direction. For example, a “top edge”, “top end” or “top side” may be directed in a first axial direction and a “bottom edge”, “bottom end” or “bottom side” may be directed in a second direction opposite to the first axial direction.

According to one embodiment, a planter comprising a planter box and a rotatable mounting adapter that couples the planter box to a surface of an object, and a first plate configured to directly couple to the planter box, a second plate configured to directly couple to the surface of the object, and one or more ball bearings between the first and second plates that allows the first plate and the planter box to rotate with respect to the second plate.

In one embodiment, the planter, further comprising a first post that extends away from and is coupled to a first side of the planter box and a second post that extends away from and is coupled to a second side of the planter box that is opposite of the first side. In another embodiment, the first and second posts each have at least one support structure that extends outward from the post. In some embodiments, for each support structure of the first post, the second post includes a corresponding support structure such that both support structures are at a same height on the respective posts with respect to the planter box. In another embodiment, the planter further includes a top attachment that is coupled to an end of the first and second posts opposite an end of the first and second posts coupled to the planter box. In some embodiments, the top attachment includes a cover that covers a side of the planter box that is opposite a side coupled to the first plate. In one embodiment, the planter includes a curtain that removeably couples to the top attachment, wherein when coupled to the top attachment the curtain wraps around the top attachment, the posts, and the planter box.

In one embodiment, the object is a ledge or railing. In another embodiment, the rotatable mounting adapter has a height from ¼ of an inch to one inch. In another embodiment, the rotatable mounting adapter is configured to rotate up to 45°. In some embodiments, the rotatable mounting adapter is configured to rotate up to 90°. In another embodiment, the planter further includes a trellis.

In one embodiment, the planter further includes a drain that is configured to allow liquid to flow out of the planter box. In another embodiment, the planter further includes a flexible hose that is removeably couples to the drain. In some embodiments, the rotatable mounting adapter includes a catch container therein that is fluidly coupled to the planter box via the drain and is arranged to collect the liquid. In one embodiment, the rotatable mounting adapter has a height from one inch to forty-two inches. In another embodiment, the planter further includes a locking mechanism that is configured to prevent the planter from rotating when in a locked position. In some embodiments, the locking mechanism includes a first structure and a second structure that are slidably coupled to the planter box. When the locking mechanism is in the locked position 1) the first structure extends below a side of the planter box that is coupled to the first plate and abuts a first side of the object, and 2) the second structure extends below the side of the planter box and abuts a second side of the object that is opposite of the first side. In some embodiments, the first structure and the second structure are coupled to one another via a bridge structure, wherein at least one of the structures includes a telescoping mechanism that is arranged to expand or contract the structure. In one embodiment, when the locking mechanism is in an unlocked position the first and second structures are both above the side of the planter box. In some embodiments, the locking mechanism includes a push button, which when depressed allows the first and second structures of the locking mechanism to slide about the planter box.

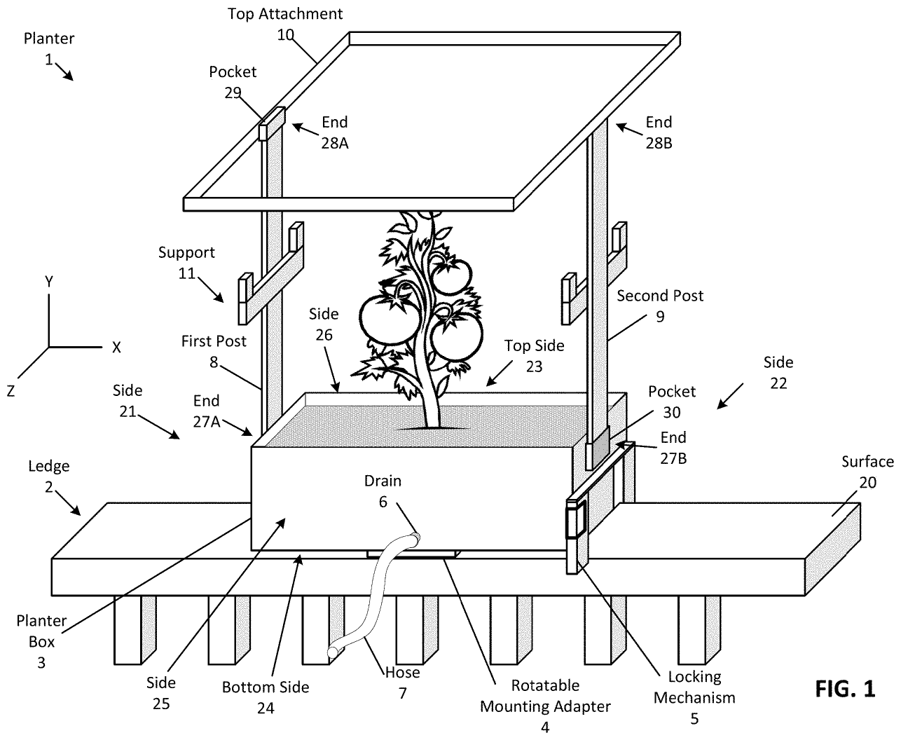

FIG. 1 illustrates a planter on top of a ledge according to one embodiment of the present disclosure. Specifically, this figure illustrates planter 1 that is on top of and rotatably coupled to a (top) surface 20 of a ledge 2. Although illustrated as being on top of a ledge, in one embodiment the planter may be placed atop any object, such as a (e.g., metal) railing or a table. In another embodiment, the planter may be placed on the ground. As illustrated, the planter includes a planter box 3, a rotatable mounting adapter 4, a locking mechanism 5, a drain 6, a hose 7, a first post 8, a second post 9, and a top attachment 10. In one embodiment, the planter may include more or less elements as described herein. For example, the planter may include two or more posts and/or two or more drains. As another example, the planter may not include a top attachment and/or may not include at least one of the posts.

The planter box 3 is a container that is configured to hold objects, such as soil and plants. The box may be any shape and size. For example, as illustrated the box has a rectangular shape, where the longitudinal sides (e.g., sides 25 and 26, which run substantially along the X-direction and are parallel with the ledge) are longer than the lateral sides (e.g., sides 21 and 22, which run substantially along the Z-direction). In one embodiment, the planter box may be square-shaped or cylindrically-shaped. In another embodiment, the planter box may include more or less sides.

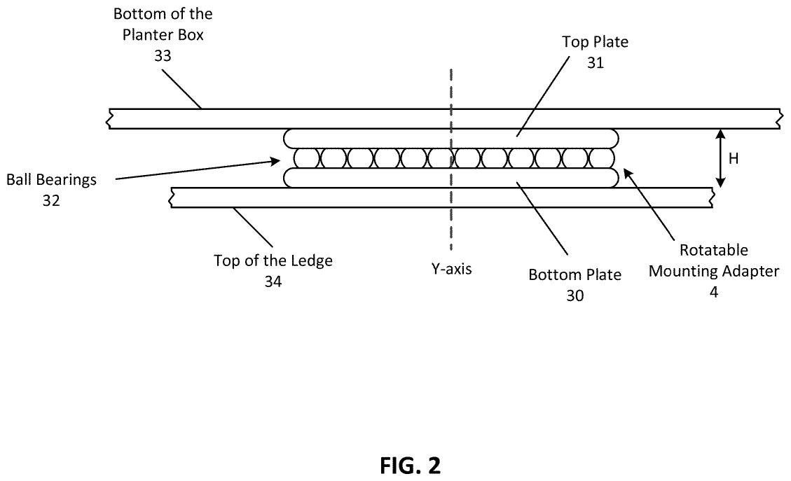

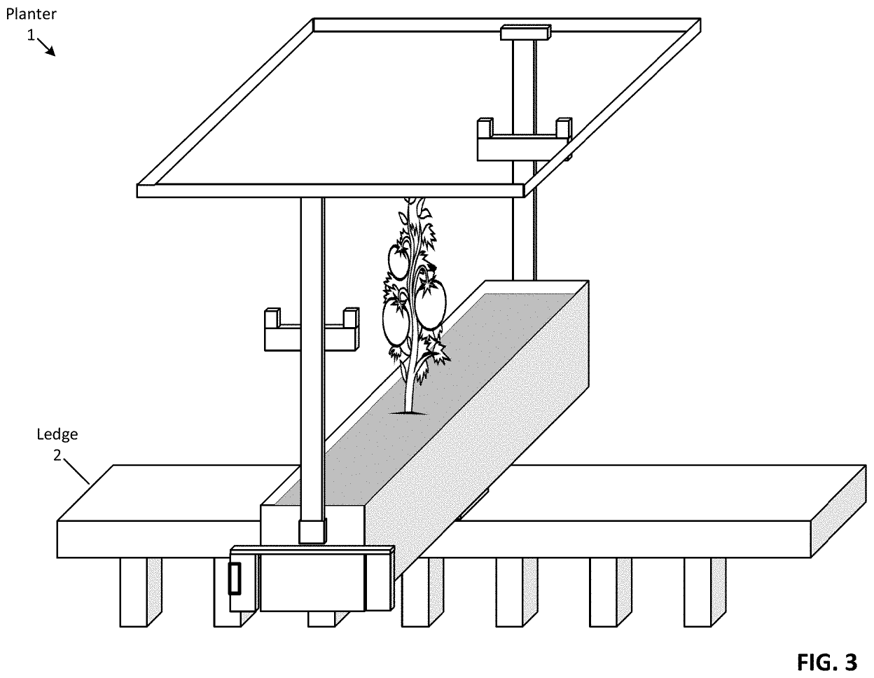

The rotatable mounting adapter 4 is configured to couple the planter box 3 to a surface of an object, such as the ledge 2, and is configured to rotate the planter box with respect to the ledge 2 (e.g., about a Y-axis). Specifically, the adapter is coupled to the bottom side 24 of the planter box, and is coupled to the surface 20 of the ledge. In one embodiment, the planter box is removeably coupled to the adapter 4 and/or the adapter is removeably coupled to the ledge 2. More about the rotatable mounting adapter is described in FIGS. 2 and 3.

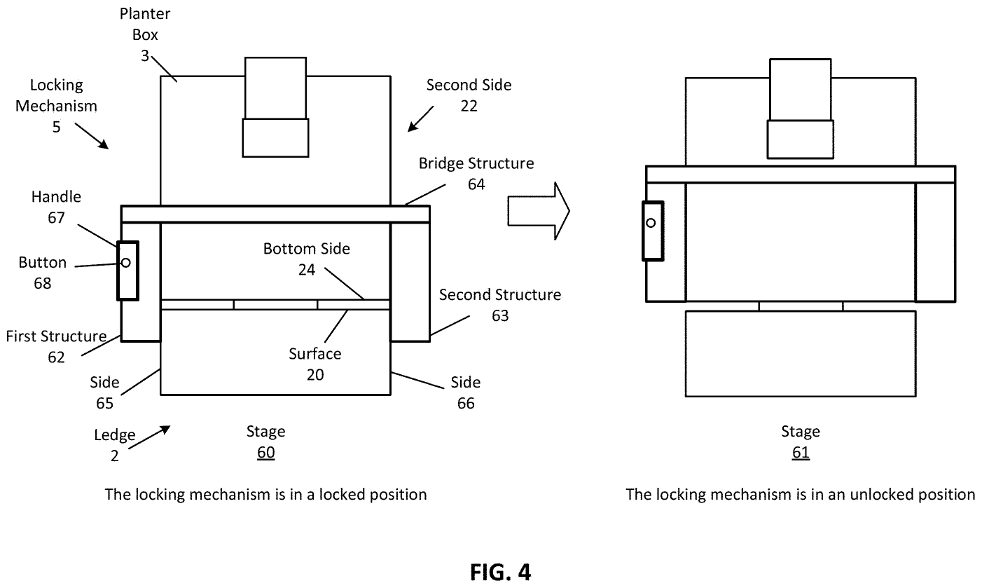

The locking mechanism 5 is configured to prevent the planter 1 from rotating when in a locked position. In one embodiment, the mechanism may have at least two positions: a locked position, as illustrated in this figure, and an unlocked position in which the planter is allowed to rotate. In some embodiments, the locking mechanism may be integrated with the rotatable mounting adapter, as described herein. More about the locking mechanism 5 is described in FIG. 4.

The drain 6 is configured to allow liquid (e.g., water) to flow out of the planter box 3. For example, the drain may be a hole that is on a side 25 of the planter box, which is closer to the bottom side 24 of the box with respect to the top side 23 of the box in order to allow water to collect at the bottom of the box and exit out into the environment. In one embodiment, the box may include one or more drains that are positioned at different locations. For example, the box may include one or more drains on one or more sides, such as side 25 and side 26. Having drains at either side may allow water to flow out and over the ledge 2 more evenly. As another example, the planter box may include one or more drains on the bottom side 24 in order to allow water to drip down and out of the box. In one embodiment, the drain 6 may have a valve that is configured to adjust the outward flow of the water. For instance, the valve may be opened in order to allow water to flow and/or be closed to prevent the flow of water.

The hose 7 is configured to removeably couple to the drain 6, such that the drain fluidly couples the (inside of the) planter box 3 to the hose in order to allow water to flow from the box and into the hose, and ultimately from the hose and into the environment. In one embodiment, the drain and the hose may include connectors (e.g., quick disconnects) that enable the hose to be coupled to the drain. In one embodiment, the hose may be composed of any material. For example, the hose may be composed of plastic (e.g., a polymer) and may be flexible. As another example, the hose may be at least partially composed of metal.

The first post 8 extends away from (e.g., in the Y-direction) and is coupled to side 21 of the planter box 3 and the second post 9 extends away from and is coupled to side 22 of the planter box 3. Specifically, an end 27A of the first post 8 is coupled to the side 21 and extends upward and above the top side 23 of the planter box, and an end 27B of the second post 9 is coupled to the side 22 and extends upward and above the top side 23 of the planter box. As illustrated, the posts 8 and 9 couple to the planter box via pockets on sides 21 and 22, such as pocket 30 on side 22. For instance, the pocket 30 may be coupled to the planter box and include an opening, through which the second post 9 may slide into. Although not illustrated, the side 21 may include a similar pocket through which the first post 8 slides into. In this case, the posts may be removeably coupled to the planter box such that the posts may be pulled out of their respective pockets. In one embodiment, the planter box may include multiple pockets on two or more sides in order to allow the position of the posts to be adjusted. In another embodiment, at least some of the posts may be fixedly coupled to (e.g., integrated with) the planter box. In some embodiments, both posts may be coupled to the box such that they are aligned with one another. For instance, post 8 is coupled along a center of side 21 along the Z-direction, and post 9 is coupled along a center of side 22 along the Z-direction. In one embodiment, the posts may be coupled to the planter box at different locations. For example, the posts may be coupled within the planter box, rather than along the outside of the planter box. In some embodiments, each of the posts 8 and 9 may be similar (e.g., having similar widths, heights, etc.), or each may be different. In other embodiments, the planter may have two or more posts.

Each of the posts includes a support structure 11 that extends outward form the posts. As illustrated, the structures are bars that are coupled to the first and second posts and extend outward along the Z-direction. Each of the structures has an extension at either end that extends upward in the Y-direction from a top of the bar. In one embodiment, the support structures may have different configurations. For instance, the structures 11 may only be bars without the extensions. As another example, the structures may include several extensions. In one embodiment, both posts may each have a similar number of support structures (e.g., one or more) that may be positioned at similar locations about the respective posts. For example, for each support structure of the first post 8, the second post includes a corresponding support structure such that both support structures are at a same height in the Y-direction on the respective posts with respect to the (e.g., top side 23 of the) planter box. In one embodiment, the support structures are fixedly coupled to the posts. In another embodiment, support structures may be removeably coupled to the support structures and/or the structures are movably coupled to the posts. For example, a user may adjust the height of support 11 on the first post 8. In one embodiment, the support structures are configured to hold objects, such as hanging planter pots or tools (e.g., a hand trowel).

The top attachment 10 is coupled to the first post 8 and the second post 9, and is positioned above the planter box 3. Specifically, the top attachment is coupled to end 28A of the first post 8 and coupled to end 28B of the second post 9, where both ends 28A and 28B are opposite ends 27A and 27B that are coupled to the planter box. In one embodiment, the top attachment is one of fixedly coupled or removeably coupled to both posts 8 and 9. For instance, as illustrated, the top attachment includes a pocket 29 in which the end 28A of the first post 8 slides into. In one embodiment, the top attachment may include multiple pockets (e.g., a pocket not shown in which the end 28B of the second post 9 slides into). Thus, the top attachment may be removed by pulling upwards and away from the ends 28A and 28B of the posts.

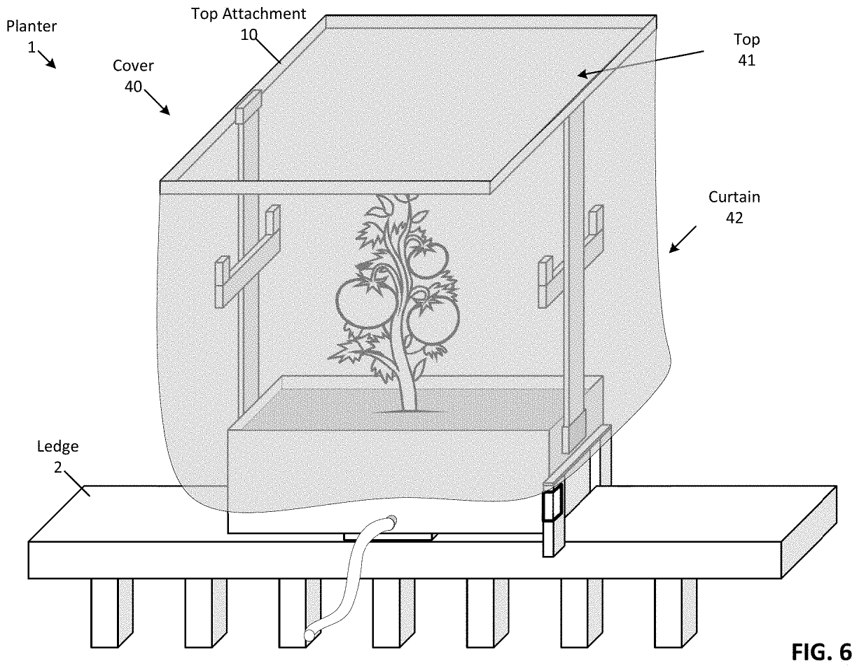

As illustrated, the top attachment is a square frame, with a hollow inside. In one embodiment, a perimeter is the top attachment is at least equal to or greater than a perimeter of the planter box. For example, since the top attachment is a square frame, each side has a width that is equal to or greater than a width of a longest side of the planter box (e.g., the width of the side 25 in the X-direction). In another embodiment, the top attachment may have any shape and size. In some embodiments, the top attachment may be user configurable. For instance, the frame of the top attachment may include telescoping sections which may be user-adjusted in order to increase/decrease the perimeter of the attachment. More about the top attachment is described in FIG. 6.

In one embodiment, the planter 1 may be composed of one or more materials, such as wood, metal, and plastic. In another embodiment, different components of the planter may be composed of different materials. For example, the planter box 3 may be at least composed of wood, while the first post 8, second post 9, and top attachment 10 are composed of a metal, such as aluminum.

FIG. 2 shows a rotatable mounting adapter of a planter according to one embodiment of the present disclosure. Specifically, this figure illustrates a side view of the rotatable mounting adapter 4, which is coupled to (the bottom side 24 of the) bottom of the planter box 33 and is coupled to (the surface 20 of the) top of the ledge 34. The adapter includes a (first) top plate 31 configured to directly couple to the planter box, a (second) bottom plate 30 configured to directly couple to an object, such as the ledge 2, and one or more ball bearings 32 between the top plate 31 and the bottom plate 30 that allows the top plate (and the planter when coupled to the top plate) to rotate with respect to the bottom plate and about a Y-axis that runs through the adapter. In one embodiment, the adapter may be any type of adapter that is configured to rotate. In another embodiment, the adapter can have a very low profile. For example, the adapter may have a height (H) that is from about X and Y inches.

In one embodiment, the rotatable mounting adapter is configured to rotate about the Y-axis clockwise and/or counter-clockwise. FIG. 3 illustrates an example in which the planter 1 has rotated clockwise 90° about the Y-axis. To rotate, a user may put the locking mechanism 5 in the unlock position, and push (or pull) on at least one side of the planter box 3 to rotate the planter. In one embodiment, the adapter is configured to rotate 360° about the Y-axis. In another embodiment, the adapter may be configured to rotate less. Specifically, the adapter may be configured to rotate up to about 90° (as illustrated in FIG. 3). For example, the adaptor may be configured to rotate from 0° to 45°.

FIG. 4 shows a locking mechanism of a planter in a locked position and in an unlocked position according to one embodiment of the present disclosure. Specifically, this figure illustrates two stages, a first stage 60 in which the locking mechanism 5 is in the locked position and a second stage 61 in which the locking mechanism is in the unlocked position. As illustrated, the locking mechanism includes a first structure 62 and a second structure 63 that are slidably coupled to the planter box 3. Both structures are coupled together via a bridge structure 64. In one embodiment, the three structures are one integrated unit.

Stage 60 illustrates the locking mechanism 5 in the locked position by the first structure 62 and the second structure 63 both extending below the bottom side 24 of the planter box and below the surface 20 of the ledge 2. Also, both structures abut the ledge 2. Specifically, the first structure 62 abuts (first) side 65, while the second structure 63 abuts (second) side 66. By abutting the sides of the ledge, the planter will remain locked in position. Stage 61 illustrates the locking mechanism 5 in the unlocked position by the first structure 62 and the second structure 63 being above the surface 20 of the ledge and/or above the bottom side 24 of the planter box. Once in this position, the user may adjust the position of the planter box.

In one embodiment, a user may cause the locking mechanism 5 to switch positions based on a selection of a button 68. For instance, the locking mechanism may be on a rail (e.g., that is a part of the second side 22) that allows the mechanism to move vertically up and down. The rail may include one or more holes, through which a pin that is coupled to the locking mechanism may enter. When a user depresses the button 68, the locking mechanism may be adjusted. For instance, once depressed, the pin may retract from a hole (and into the locking mechanism). The user may grasp the handle 67 and move the locking mechanism, allowing the structures of the locking mechanism to move vertically about the planter box 3. Once in a desired position, the user may release the button 68, enabling the locking mechanism to lock into place. Specifically, once released, the pin extends away from the mechanism and inward into another hole in the railing, causing the locking mechanism to remain in its position. In some embodiments, the locking mechanism may be arranged in two or more (locking) positions. For instance, the number of positions may be based on the number of holes included within the rail, as described herein. In another embodiment, the locking mechanism may operate differently.

In one embodiment, the dimensions of the locking mechanism 5 may be adjustable. In particular, at least one of the first structure, the second structure, and bridge structure may include a telescopic mechanism that is arranged to expand or contract the structure. For instance, the bridge structure 64 may include the telescopic mechanism that allows the structure to expand the width of the locking mechanism. This may allow the locking mechanism to fit around ledges having different widths.

In another embodiment, the locking mechanism 5 may be integrated within the rotatable mounting adapter 4. Referring to FIG. 2, the locking mechanism may be a part of the rotatable mounting adapter such that the top plate 31 of the adapter includes a pin, while the bottom plate 30 includes a hole (or indentation) that is arranged to receive the pin. To rotate the planter 1, the pin may be retracted from a hole (thereby putting the locking mechanism in an unlocked position), and a user may rotate the planter (e.g., by pushing on a side of the planter). Once rotated to a user-desired position, the pin may be inserted in a different hole of the bottom plate 30 to put the locking mechanism in a locked position. Thus, the bottom plate may include two or more holes positioned radially along the Y-axis. In one embodiment, the holes may be evenly positioned about the Y-axis (e.g., every 22.5° or every 45°). In one embodiment, the position of the pin may be adjusted via a selection of a button (e.g., button 68).

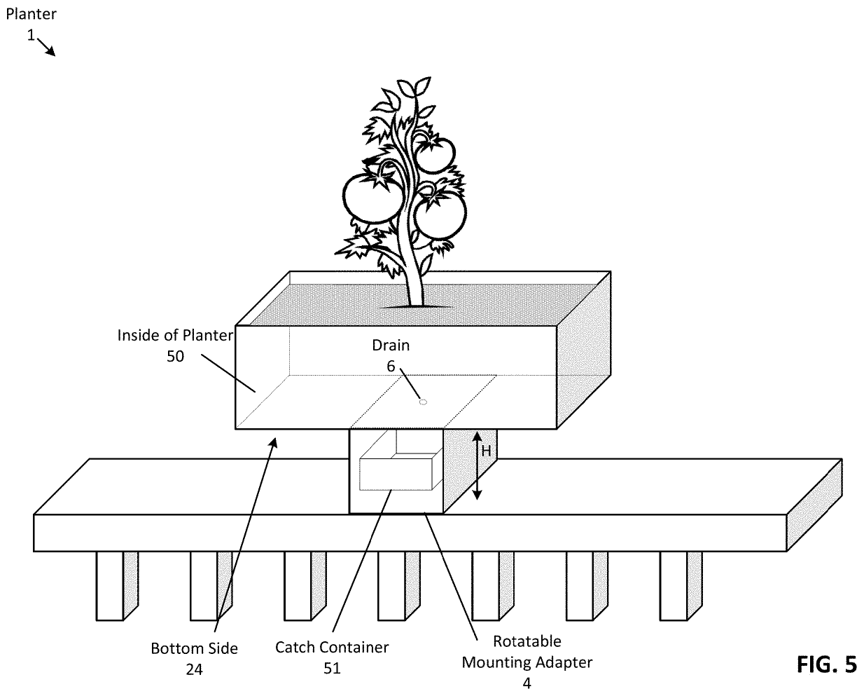

FIG. 5 shows a perspective view of planter 1 that has a rotatable mounting adapter with a catch container according to one embodiment of the present disclosure. Specifically, as shown, the rotatable mounting adapter 4 includes a catch container 51 that is arranged to be positioned inside the adapter. In one embodiment, the catch container may be removed from the adapter. In another embodiment, the container is a part of the adapter. Also shown, the drain 6 is positioned at the bottom side 24 of the planter box 3. This allows the inside of the planter 50 to be fluidly coupled with the catch container 51 via the drain 6. This allows any excess liquid to flow out form the drain 6 and to be caught by the container 51. Once filed, the user may empty the container. In one embodiment, the rotatable mounting adapter 4 may have a height (“H”) that allows for the adapter to include the container. For instance, H may be from one inch to forty-two inches. As another example, H may be from ¼ of an inch to forty-two inches.

As illustrated, the adapter 4 is a square box. In one embodiment, the adapter may have any configuration and/or design. For instance, the adapter may have a cylindrical shape. Although not illustrated, the adapter may also include the top plate 30, the ball bearings 32, and bottom plate 30, as illustrated in FIG. 2. In one embodiment, the plates and bearings may be positioned at the top of the adapter (e.g., coupled to the bottom side 24 of the box 3, or on the bottom (e.g., coupled to the surface of the ledge).

FIG. 6 shows a cover that is covering a planter according to one embodiment of the present disclosure. Specifically, this figure illustrates that the top attachment 10 includes a cover 40 that at least partially covers the top side 23 and/or one or more sides (e.g., sides 21, 22, 25, and 26). As illustrated, the cover includes a top 41 and a curtain 42. The top is configured to cover the inside of the top attachment. In one embodiment, the top may be composed of a hard material, such as plastic or metal. The curtain is configured to cover at least a portion of the planter box by draping below the top side 23 of the box. In one embodiment, the curtain may be composed of a pliable material, such as cloth or nylon. In some embodiments, the curtain may be water proof.

In one embodiment, the top 41 and the curtain 42 are two separate components. In this case, the curtain may be configured to removeably couple to the top attachment. For instance, the top attachment may have clips that may attach to the curtain. In another embodiment, the top and the curtain are an integrated unit. In this case, when the curtain is coupled to the top attachment, the curtain may wrap around the top attachment, the posts 8 and 9, and at least a portion of the planter box 3.

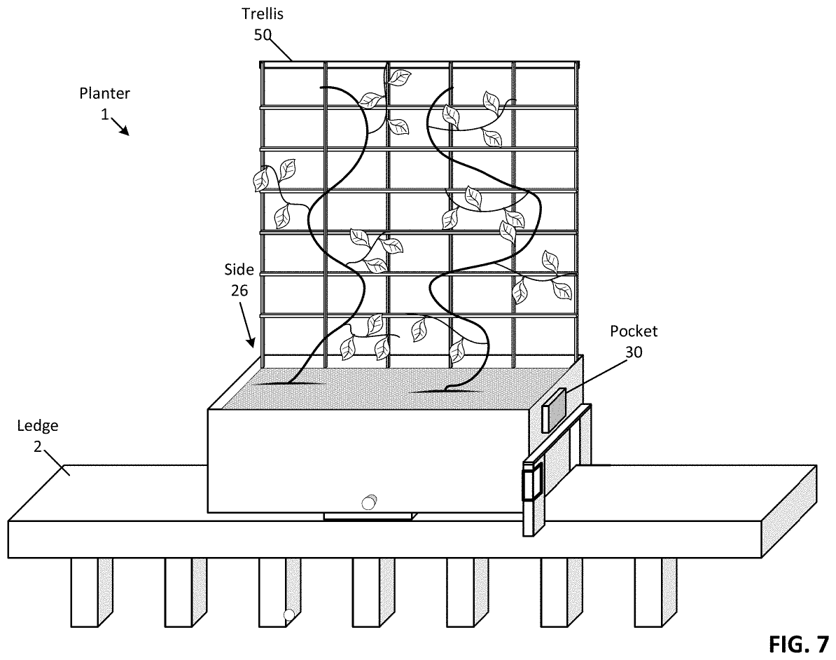

FIG. 7 shows a planter that has at least one trellis according to one embodiment of the present disclosure. Specifically, this figure illustrates planter 1 that includes a trellis 50, which is a structure of intersecting bars and posts. In one embodiment, the trellis may be composed of any material, such as wood or metal. As illustrated, the trellis is coupled to (e.g., an interior wall of) the side 26. In one embodiment, the planter may include one or more pockets, similar to pocket 30, that enable the trellis to be added and removed from the planter box 3. In one embodiment, the trellis may couple to a post, such as the first post 8 (see FIG. 1), rather than (or in addition to) coupling to a side of the planter box. In another embodiment, the planter is configured to have several trellises. For instance, along with the trellis 50 that is coupled to the side 26, the planter may include another trellis that is coupled to one of the planter box's lateral sides, such as the first side 21 (see FIG. 1). In one embodiment, when the posts (first post 8 and second post 9) are coupled to the planter box 3, the trellis along with the posts may couple to the top attachment.

In one embodiment, the trellis may provide a user with enhanced privacy. For instance, when placed on a ledge of an apartment's patio, plants that grown on and around the trellis may block a field of view into the apartment from beyond the apartment's patio.

While certain embodiments have been described and shown in the accompanying drawings, it is to be understood that such embodiments are merely illustrative of and not restrictive on the broad disclosure, and that the disclosure is not limited to the specific constructions and arrangements shown and described, since various other modifications may occur to those of ordinary skill in the art.

What is claimed is:

1. A planter comprising:
a planter box;
a rotatable mounting adapter that couples the planter box to a surface of an object, wherein the adapter includes a first plate configured to directly couple to the planter box, a second plate configured to directly couple to the surface of the object, and one or more ball bearings between the first and second plates that allows the first plate and the planter box to rotate with respect to the second plate.

2. The planter of claim 1, further comprising:
a first post that extends away from and is coupled to a first side of the planter box and a second post that extends away from and is coupled to a second side of the planter box that is opposite of the first side.

3. The planter of claim 2, wherein the first and second posts each have at least one support structure that extends outward from the post.

4. The planter of claim 3, wherein for each support structure of the first post, the second post includes a corresponding support structure such that both support structures are at a same height on the respective posts with respect to the planter box.

5. The planter of claim 2, further comprising:
a top attachment that is coupled to an end of the first and second posts opposite an end of the first and second posts coupled to the planter box.

6. The planter of claim 5, wherein the top attachment comprises a cover that covers a side of the planter box that is opposite a side coupled to the first plate.

7. The planter of claim 5, further comprising:
a curtain that removeably couples to the top attachment, wherein when coupled to the top attachment the curtain wraps around the top attachment, the posts, and the planter box.

8. The planter of claim 1, wherein the rotatable mounting adapter has a height from ¼ of an inch to one inch.

9. The planter of claim 1, wherein the rotatable mounting adapter is configured to rotate up to 45°.

10. The planter of claim 1, wherein the rotatable mounting adapter is configured to rotate 90°.

11. The planter of claim 1, further comprising: a trellis.

12. The planter of claim 1, further comprising: a drain that is configured to allow liquid to flow out of the planter box.

13. The planter of claim 12, further comprising: a flexible hose that is removeably couples to the drain.

14. The planter of claim 12, wherein the rotatable mounting adapter comprises a catch container therein that is fluidly coupled to the planter box via the drain and is arranged to collect the liquid.

15. The planter of claim 14, wherein the rotatable mounting adapter has a height from one inch to forty-two inches.

16. The planter of claim 1, further comprising: a locking mechanism that is configured to prevent the planter from rotating when in a locked position.

17. The planter of claim 16, wherein the locking mechanism comprises a first structure and a second structure that are slidably coupled to the planter box, wherein, when the locking mechanism is in the locked position
the first structure extends below a side of the planter box that is coupled to the first plate and abuts a first side of the object, and
the second structure extends below the side of the planter box and abuts a second side of the object that is opposite of the first side.

18. The planter of claim 17, wherein the first structure and the second structure are coupled to one another via a bridge structure, wherein at least one of the structures comprises a telescopic mechanism that is arranged to expand or contract the structure.

19. The planter of claim 17, wherein, when the locking mechanism is in an unlocked position the first and second structures are both above the side of the planter box.

20. The planter of claim 17, wherein the locking mechanism comprises a push button, which when depressed allows the first and second structures of the locking mechanism to slide about the planter box.
